(19) United States
(12) Patent Application Publication
(10) Pub. No.: US 2023/0376838 A1
(43) Pub. Date: Nov. 23, 2023

(54) MACHINE LEARNING PREDICTION OF WORKFLOW STEPS

(71) Applicant: ServiceNow, Inc., Santa Clara, CA (US)

(72) Inventors: Amine El Hattami, Montreal (CA); Christopher Joseph Pal, Montreal (CA); David María Vázquez Bermúdez, Montreal (CA); Issam Hadj Laradji, Vancouver (CA); Stefania Evelina Raimondo, Toronto (CA)

(21) Appl. No.: 17/751,464

(22) Filed: May 23, 2022

(51) Int. Cl. G06N 20/00

(52) U.S. Cl. CPC G06N 20/00

(57) ABSTRACT

Content of a dialog between at least two communication parties to resolve a task is received. A specification associated with at least a portion of eligible steps of a workflow is received. Machine learning input data is determined based on the received content of the dialog and the received specification. The determined machine learning input data is processed using a trained machine learning model executing on one or more hardware processors to automatically predict a sequence of workflow steps representing the dialog.

### BACKGROUND OF THE INVENTION

Text-based dialogues are widely used to solve real-world problems. In some scenarios, text-based dialogues are generated between a user and a dialogue system. Examples of such a dialogue system are interactive conversational agents, virtual agents, chatbots, and so forth. Text-based dialogues can also be generated without the presence of a dialogue system. In some scenarios, text-based dialogues can be generated from audio or video dialogues using audio/video-to-text techniques. The content of text-based dialogues is wide-ranging and can cover technical support services, customer support, entertainment, or other topics. Text-based dialogues can be long and/or complex. Thus, there is a need for techniques directed toward analyzing text-based dialogues.

### BRIEF DESCRIPTION OF THE DRAWINGS

Various embodiments of the invention are disclosed in the following detailed description and the accompanying drawings.

FIG. 1 is a block diagram illustrating an embodiment of a system for predicting workflow steps.

FIG. 2A is a block diagram illustrating an alternative embodiment of a system for predicting workflow steps.

FIG. 2B is a block diagram illustrating an embodiment of a system for performing domain discovery.

FIG. 3 illustrates an example of an invented step.

FIG. 4 is a flow diagram illustrating an embodiment of a process for predicting workflow steps.

FIG. 5 is a flow diagram illustrating an embodiment of a process for training a machine learning model to predict workflow steps.

FIG. 6 is a functional diagram illustrating a programmed computer system.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Machine learning prediction of workflow steps is disclosed. Content of a dialog between at least two communication parties to resolve a task is received. A specification associated with at least a portion of eligible steps of a workflow is received. Machine learning input data is determined based on the received content of the dialog and the received specification. The determined machine learning input data is fed to a trained machine learning model executing on one or more hardware processors to automatically predict a sequence of workflow steps representing the dialog.

The techniques disclosed herein allow for the extraction of workflows from dialogues. As used herein, a dialogue, which can also be spelled “dialog”, refers to a text-based conversation. The dialogue may be between a client and an agent regarding a real-world problem to solve. The agent can be a virtual agent, such as a chatbot. As used herein, a workflow, which can also be called an “action flow”, “flow”, and so forth, refers to a sequence of actions and/or steps. These actions and/or steps are oftentimes the actions and/or steps an agent has followed to address a real-world problem of a human user.

As described in further detail herein, in various embodiments, a text-to-text machine learning model is utilized to perform a type of dialogue summarization in which the steps used to resolve a problem during the dialogue are summarized as a workflow. In various embodiments, the dialogue summarization includes an optional conditioning technique that involves providing a set of allowable action steps to a machine learning model. This conditioning technique improves workflow discovery (WD) performance, including in scenarios in which the machine learning model has had no exposure (zero-shot) or little exposure (few-shot) to the types of workflow steps it is expected to extract. In various embodiments, an entire dialogue is utilized as an input to the machine learning model and a sequence of high-level actions is the generated output. In various embodiments, a set of possible actions from which to select for the output is another optional input to the machine learning model used to condition (e.g., constrain) the machine learning model.

The techniques disclosed herein solve the problem of discovering steps of actions that have been taken to resolve problems in situations where a formal workflow does not yet exist. These steps of actions may be used to understand the process that an employee takes in order to solve a particular customer request. This is particularly beneficial in scenarios in which there is variation with respect to how a specific issue is resolved (e.g., because different agents may resolve the issue differently). Even in scenarios in which a formal workflow exists, some agents/employees may sometimes follow “unwritten rules” or rules that have not yet been added to the formal workflow. In these situations, a machine learning framework that automatically extracts workflows from dialogues between customers and agents has benefits, including identifying interactions where the formal workflow was not followed, which can be used to enhance existing workflows. The techniques disclosed herein are widely applicable because task-oriented dialogues are ubiquitous in everyday life (and in customer service in particular). For example, customer service agents may use dialogues to help customers book restaurants, make travel plans, and receive assistance for complex problems. Behind these dialogues, there may be either implicit or explicit workflows of actions and steps that the agent has followed to make sure the customer request is adequately addressed. For example, booking an airline ticket might require the following workflow: pull-up account, register seat, and request payment. The techniques disclosed herein solve the problem of correctly identifying each of the actions constituting a workflow without relying on human expertise even when the set of possible actions and procedures may change over time.

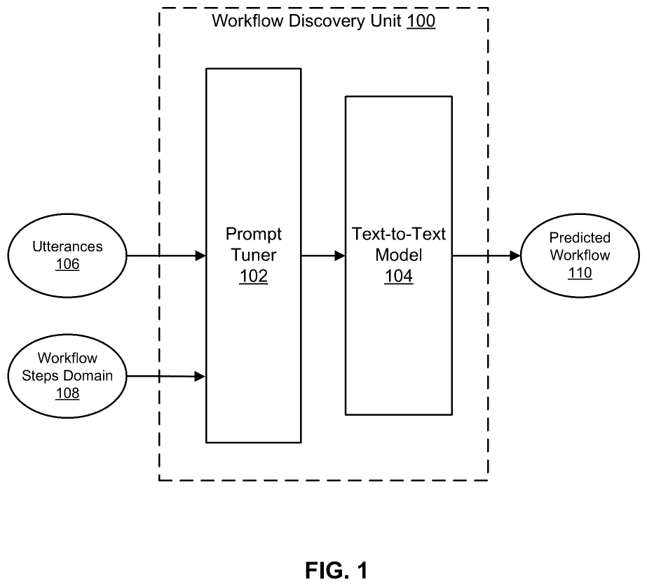

FIG. 1 is a block diagram illustrating an embodiment of a system for predicting workflow steps. In the example illustrated, workflow discovery unit 100 includes prompt tuner 102 and text-to-text model 104. Workflow discovery unit 100 receives utterances 106 and an optional workflow steps domain 108 in order to output predicted workflow 110.

Workflow discovery unit 100 extracts a set of steps (such as actions or intents) from a task-oriented dialogue. A workflow can be defined as a set of workflow steps in a specific order followed to accomplish a task or a set of tasks during a dialogue. Given 1) a dialogue of utterances D={u₁, u₂, . . . , uₙ}, where n is the total number of utterances in the dialogue, and each utterance can be from any party and 2) an optional workflow step domain δ={(s₁, d₁), (s₂, d₂), . . . , (s_{z}, d_{z})}, where z is the total number of workflow steps and each step name s is a unique step name with a corresponding unique workflow step natural language description d, workflow discovery unit 100 predicts a target workflow W={s₁, s₂, sₜ}, where each s∈δ. In the example illustrated, D={u₁, u₂, . . . , uₙ}, δ={(s₁, d₁), (s₂, d₂), . . . , (s_{z}, d_{z})}, and W={s₁, s₂, . . . , sₜ} correspond to utterances 106, workflow steps domain 108, and predicted workflow 110, respectively. In various embodiments, text-to-text model 104 is a machine learning model that generates W={s₁, s₂, . . . , sₜ}.

The techniques disclosed herein can be utilized in several operational modes depending on whether the target workflow actions are known or from a different domain. In an “in-domain, in-distribution” mode, text-to-text model 104 model has seen all possible steps {s₁, s₂, . . . , sₜ} during training, meaning workflow steps domain 108 can be omitted. In an “in-domain, out-of-distribution” mode, text-to-text model 104 model has seen all the possible steps during training except perhaps a few of the steps. However, the missing steps are in the same domain as the ones seen during training. In this mode, if workflow steps domain 108 is not specified, text-to-text model 104 can invent the missing steps and determine new step names for the invented steps. If workflow steps domain 108 is provided, text-to-text model 104 may first determine whether one of the provided step names in workflow steps domain 108 is plausible before determining a new step name. For example, if the dialogue includes a step in which an agent verifies the customer's identity, text-to-text model 104 may predict “check identity” if workflow steps domain 108 is not specified. However, if workflow steps domain 108 is specified and includes “verify identity”, text-to-text model 104 would use “verify identity” instead of “check identity”. Using workflow steps domain 108 in this mode promotes uniformity of step names across multiple predictions. Instead of predicting “check identity” for one dialogue and “verify identity” for another, text-to-text model 104 would uniformly use “verify identity”. While both step names are semantically identical, using workflow steps domain 108 eliminates the need for any post-processing to group dialogues that have semantically similar workflows with different nomenclature.

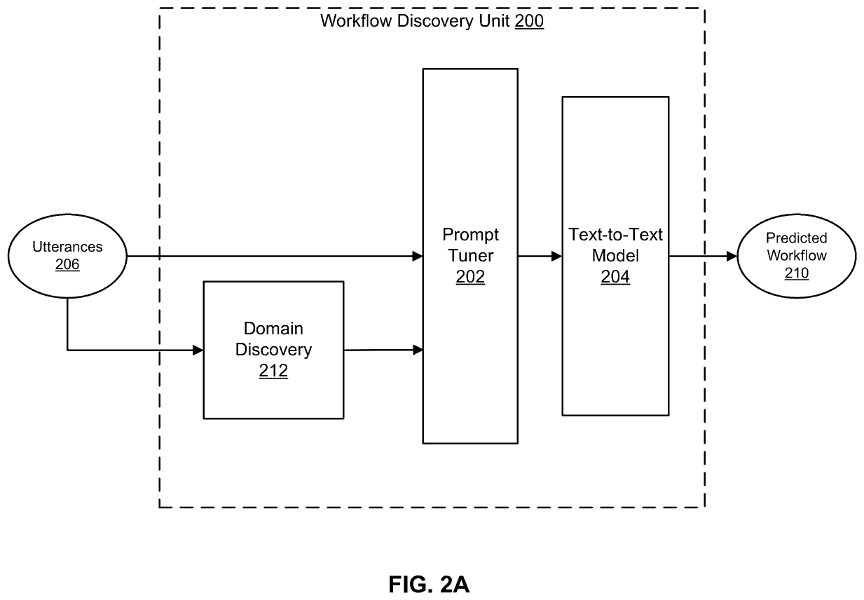

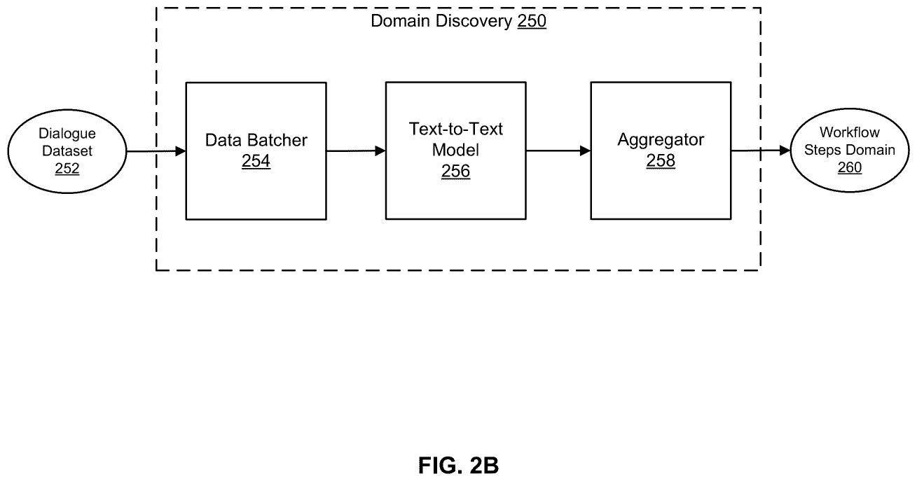

In an “out-of-domain mode”, text-to-text model 104 has never seen the target workflow actions/steps during training and the steps are from a different domain (e.g., when text-to-text model 104 is trained on a restaurants/hotels domain but the target workflow is in an information technology domain). In this mode, if workflow steps domain 108 is not specified, text-to-text model 104 determines plausible step names, which is useful in scenarios in which the steps are not known. If the steps domain is specified or partially specified via workflow steps domain 108, text-to-text model 104 would first determine whether one of the specified steps is plausible before inventing a new step. This has the advantage of avoiding training of a new model, which reduces costs, especially for rapidly evolving domains. For scenarios in which the steps domain is not known and a dataset of unlabeled dialogues is available, a domain discovery system can be utilized to extract a domain (e.g., see FIGS. 2A-B). The extracted domain can be used as an input to the workflow discovery system. An advantage of using the extracted domain is promoting uniformity of step names across multiple predictions (e.g., see above “check identity” versus “verify identity” example).

In the example illustrated, prompt tuner 102 formats received data and outputs the formatted data to text-to-text model 104. In the example shown, prompt tuner 102 formats utterances 106 and workflow steps domain 108. In some embodiments, the output of prompt tuner 102 is a concatenation of utterances 106 and workflow steps domain 108 with prefixes added. For example, if utterances 106 is D={“utt₁”, . . . “uttₙ”} and workflow steps domain 108 is δ={(“step₁”, “desc₁”), (“step_{z}”, “desc_{z}”)}, then the output of tuner 102 may be “Dialogue: utt₁ . . . uttₙ Steps: desc₁, . . . desc_{z})”. Here, “Dialogue:” and “Steps:” are prefixes to help text-to-text model 104 differentiate between utterances 106 and workflow steps domain 108. When workflow steps domain 108 is not provided, the output of prompt tuner 102 would be “Dialogue: utt₁ . . . uttₙ”.

The techniques disclosed herein can also be applied to other conversation mediums, such as audio or video. For embodiments in which an audio or video conversation is received, workflow discovery unit 100 can include a media-to-text converter module that receives the audio and/or video and converts the audio and/or video to text. For example, to convert audio to text, any one of various speech recognition techniques known to those skilled in the art may be utilized to generate a text form (e.g., in the same format as utterances 106) of the audio input. Workflow discovery unit 100 can then utilize the text form in the same manner as that described for utterances 106. Similarly, video-to-text techniques known to those skilled in the art may be utilized to generate the text form from a video input.

In various embodiments, text-to-text model 104 performs the WD task, which can be cast as a text-to-text sequence summarization task in which the target (output) is predicted workflow 110, which is text that starts with the prefix “Flow:” followed by workflow step descriptions joined by a comma. For example, for a target workflow W={(“step₁”, “desc₁”), (“step₂”, “desc₂”)}, the target text for predicted workflow 110 could be “Flow: desc₁, desc₂”. As a specific example, suppose a dialogues of {“AGENT: Hi, how can I help you?”, “CUSTOMER: I'm needing to check on the status of my subscription.”, . . . “CUSTOMER: That will be all.”, “AGENT: Then thank you for being a customer and have a great day!”} and workflow steps descriptions of {“offer-refund”, “offer-promo-code”, “subscription-status”, “send-link”, “search-order”, “enter-details”, “pull-up-account”, “verify-identity”}. The final model output may be “Flow: pull-up account, verify-identity, order status, send-link”. In the above dialogue, the agent can be a human or a virtual agent (e.g., a chatbot). It is also possible for the customer to be a virtual agent.

In some embodiments, predicted workflow 110 is in a format that includes extracted parameters. Stated alternatively, text-to-text model 104 would have been trained to output both steps and their parameters. For example, predicted workflow 110 may have the following format: “Flow: Step X [Parameter A], Step Y, Step Z [Parameter B, Parameter C]”, where “Flow:” is a prefix to the predicted workflow, Steps X, Y, and Z are the steps the agent follows to resolve the customer issue, and wherein a step can have zero, one, or more parameters. Here, Step X has one parameter (Parameter A), Step Z has two parameters (Parameters B and C), and Step Y has no parameters. The following is an example of a predicted workflow with parameters: “Flow: pull-up account [amine@mail.com], verify identity, offer promo code [CODE123, 20$]”. Here, “pull-up account”, “verify identity”, and “offer promo code” are the workflow steps. Furthermore, “amine@mail.com” is the parameter for the “pull-up account” step, and “Code123” and “20$” are the parameters for the “offer promo code” step.

The architecture of text-to-text model 104 may be based on various machine learning architectures configured to perform end-to-end learning of semantic mappings from input to output, including transformers and recurrent neural networks (RNNs) (large language models (LLMs)). Text-to-text model 104 has been trained on text examples and is configured to receive a text input and generate a text output. In various embodiments, text-to-text model 104 has been trained by utilizing transfer learning. Transfer learning refers to first pre-training a model on a data-rich task and then fine-tuning the model on a downstream task. For example, in some embodiments, text-to-text model 104 is pre-trained for English summarization as the base model upon which refined model variants are built. In various embodiments, after pre-training and during the refinement phase of training, text-to-text model 104 is trained based on ground truth workflows. Stated alternatively, text-to-text model 104 can be trained using labeled training data in which correct workflows summarizing corresponding dialogues are manually determined. In some embodiments, text-to-text model 104 is pre-trained on text summarization (e.g., converting a large paragraph into a smaller one), further pre-trained on a large dataset in general conversion of dialogues to workflows, and then refined using specific annotated examples. In some embodiments, text-to-text model 104 is a LLM that has an Encoder-Decoder architecture. An example of a LLM model with an Encoder-Decoder architecture is the T5 model. An advantage of an Encoder-Decoder architecture is that it facilitates adapting to new tasks since any task can be cast as a text-to-text task.

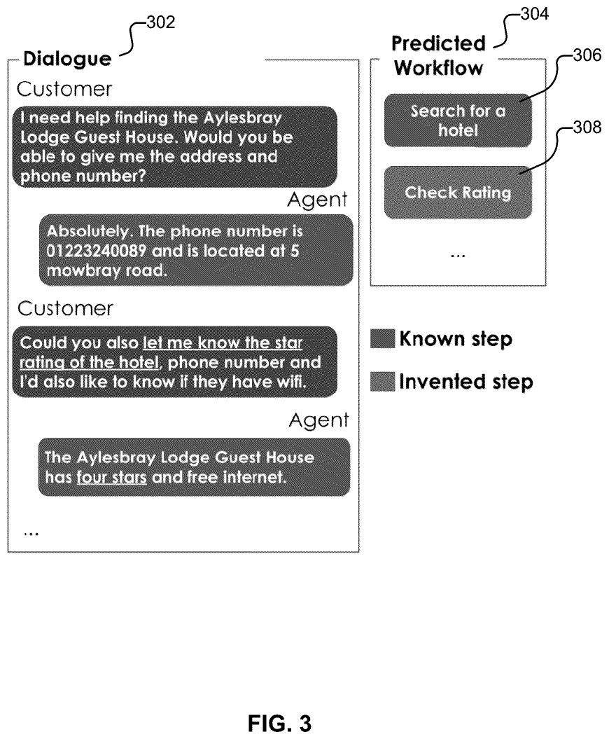

Another advantage of an Encoder-Decoder architecture is that it handles out-of-domain predictions (e.g., by inventing steps that are not explicitly found in workflow steps domain 108). Stated alternatively, never before seen steps can be determined by text-to-text model 104. FIG. 3 illustrates an example of an invented step. In the example shown in FIG. 3, a machine learning model (e.g., text-to-text model 104) ingests dialogue 302 and produces predicted workflow 304. Predicted workflow 304 includes step 306, which is a known step (e.g., present in workflow steps domain 108 or seen during training). Predicted workflow 304 also includes step 308, which is an invented step (e.g., not present in workflow steps domain 108 nor seen during training). Step prediction is possible because of the natural language training of the machine language models described herein. For example, because text-to-text model 104 may be pre-trained for summarization, it would be reasonable for the model to infer “check rating” based on the utterances related to rating of a hotel in dialogue 302. The training of text-to-text model 104 pretrained on language allows for superior zero-shot and few shot-performance. Zero-shot refers to a new domain for text-to-text model 104, and few-shot indicates that text-to-text model 104 has been trained with only a few annotated examples. Thus, text-to-text model 104 is able to output a known step, modified step (modification being slight), or invented step.

In the example shown, portions of the communication path between the components are shown. Other communication paths may exist, and the example of FIG. 1 has been simplified to illustrate the example clearly. Although single instances of components have been shown to simplify the diagram, additional instances of any of the components shown in FIG. 1 may exist. The number of components and the connections shown in FIG. 1 are merely illustrative. Components not shown in FIG. 1 may also exist.

FIG. 2A is a block diagram illustrating an alternative embodiment of a system for predicting workflow steps. In the example illustrated, workflow discovery unit 200 includes prompt tuner 202, text-to-text model 204, and domain discovery 212. Workflow discovery unit 200 receives utterances 206 in order to output predicted workflow 210. In some embodiments, prompt tuner 202 is prompt tuner 102 of FIG. 1. In some embodiments, text-to-text model 204 is text-to-text model 104 of FIG. 1. In some embodiments, utterances 206 is utterances 106 of FIG. 1. In some embodiments, predicted workflow 210 is predicted workflow 110 of FIG. 1. Workflow discovery unit 200 differs from workflow discovery unit 100 of FIG. 1 in that a domain is not already known (workflow steps domain not provided to workflow discovery unit 200) and is instead determined by domain discovery 212 based at least in part on utterances 206.

In some embodiments, domain discovery 212 includes a text-to-text machine learning model that is separate from text-to-text model 204 and that has been trained to extract a domain from a set of dialogues, wherein each domain is comprised of a list of workflow steps (e.g., workflow steps domain 108 of FIG. 1). In various embodiments, domain discovery 212 has been trained using training instances in which each training instance is a dialogue (a series of utterances) input and a target domain labeled output. Domain discovery 212 may employ a similar architecture as text-to-text model 204 and be similarly trained. In various embodiments, the domains that domain discovery 212 has been trained to output are the same domains that are options to be provided to workflow discovery unit 100 of FIG. 1 in the form of workflow steps domain 108. In workflow discovery unit 200, the domain is automatically selected (e.g., because the domain is not known beforehand). In this manner, text-to-text model 204 can still be conditioned by a list of available workflow steps that is domain-dependent. As with text-to-text model 104 of FIG. 1, text-to-text model 204 can also select out-of-domain workflow steps due to the natural language training of text-to-text model 204 (e.g., see FIG. 3 for an example of an invented step).

FIG. 2B is a block diagram illustrating an embodiment of a system for performing domain discovery. In some embodiments, domain discovery 250 is domain discovery 212 of FIG. 2A. In the example illustrated, domain discovery 250 includes data batcher 254, text-to-text model 256, and aggregator 258. In the example illustrated, domain discovery 250 receives dialogue dataset 252 and outputs workflow steps domain 260. Domain discovery 250 extracts a domain from a task-oriented dialogue dataset in cases in which the domain is unknown and/or difficult to determine.

In various embodiments, dialogue dataset 252 is a dataset of task-oriented dialogues in their raw text format. In some embodiments, utterances 206 of FIG. 2A is included in dialogue dataset 252. Thus, although not explicitly shown in FIG. 2A, domain discovery 212 of FIG. 2A may receive a dataset of many dialogues and perform batch domain discovery in an offline setup. An advantage of feeding the entire dataset in an offline setup instead of executing domain discovery on each dialogue in an online setup is getting high-level step names. For example, suppose three dialogues each of which includes one of following utterances: “I want to book a Chinese restaurant”, “I want to book a Moroccan restaurant”, and “I want to book a French restaurant”. If analyzed independently, three different steps, “book a Moroccan restaurant”, “book a French restaurant”, and “book a Chinese restaurant” might be predicted. On the other hand, when analyzed together, a single step, “book restaurant”, can be predicted. Thus, a machine learning model would understand that Chinese, Moroccan, and French are parameters of the “book restaurant” step.

Data batcher 254 splits dialogue dataset 252 into multiple batches and transmits them one by one to text-to-text model 256. In various embodiments, data batcher 254 places semantically similar dialogues in the same batch. For example, data batcher 254 may select a random dialogue and then determine matching dialogues by ranking all the other dialogues using a similarity metric (e.g., cosine similarity). Once ranked, data batcher 254 can group dialogues until each batch is full. For example, suppose four dialogues each of which includes one of the following utterances: “Dialogue 1: I want to book a Chinese restaurant”, “Dialogue 2: I want to book a Moroccan restaurant”, “Dialogue 3: I want the number of a French restaurant”, and “Dialogue 4: When does XYZ restaurant open” and further suppose that the batch size is two. If Dialogues 1 and 2 are not placed in the same batch, text-to-text model 256 might predict separate “book a Moroccan restaurant” and “book a Chinese restaurant” steps instead of a single “book restaurant” step. While some of these use cases can be corrected by aggregator 258, handling them upstream reduces the complexity of aggregator 258. In various embodiments, data batcher 254 minimizes the total number of batches by finding an optimal arrangement of dialogues in the batch.

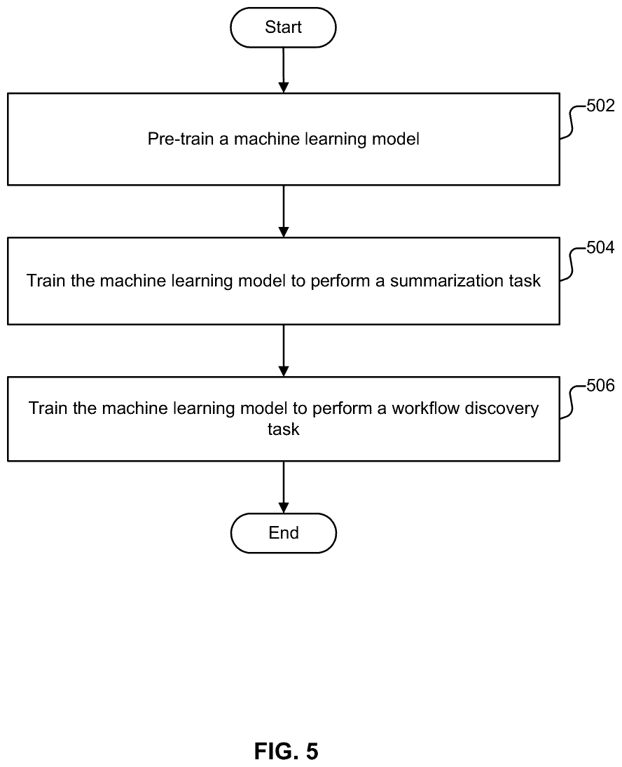

Text-to-text model 256 is a machine learning model that predicts a set of steps that best describe an input batch, wherein each batch has a distinct set of predicted steps. In some embodiments, text-to-text model 256 is trained in a three-stage process: pre-training, summarization fine-tuning, and domain discovery fine-tuning. In various embodiments, during the pre-training stage, text-to-text model 256 is pre-trained using a mixture of unlabeled and labeled text. The unlabeled data can used for an unsupervised denoising objective, and the labeled data can be used for a supervised text-to-text language modeling objective. Text-to-text model 256 can be trained to “understand” language using a masked language model objective. In various embodiments, during the summarization fine-tuning stage, text-to-text model 256 is fine-tuned in a supervised mode using a labeled dataset to be trained to perform a text summarization task for which the input is a relatively large amount of text (e.g., a paragraph) and the output is a short summary (e.g., a sentence). In various embodiments, during the domain discovery fine-tuning stage, text-to-text model 256 is fine-tuned in a supervised mode on at least two datasets from different known domains to be trained to perform a domain discovery task. Text-to-text model 256 is a trained model that is not dedicated to a specific dialogue domain; rather, it is trained to extract workflow steps regardless of the domain. In some embodiments, this three-stage training process is the same as the process of FIG. 5 except the machine learning model is trained to perform domain discovery in the last stage instead of workflow discovery.

Aggregator 258 execution occurs after text-to-text model 256 predicts the steps for all the batches. Because text-to-text model 256 predicts a set of steps for each batch, there could be cases in which the sets have duplicate and semantically equivalent steps. In various embodiments, aggregator 258 determines best step names for a given dataset by removing duplicates and semantically equivalent steps based on a similarity metric (e.g., cosine similarity). In various embodiments, aggregator 258 also determines most concise step names for semantically equivalent steps. For example, suppose two batches and the predicted steps for the first batch are: “verify identity”, “pull up account”, and “offer refund” and the predicted steps for the second batch are: “check customer identity”, “pull up account”, and “send email”. In such a scenario, the output of aggregator 258 could be: “verify identity” “pull up account”, “offer refund”, and “send email”.

In various embodiments, workflow steps domain 260 is a list of eligible steps. Stated alternatively, in various embodiments, a discovered domain is reported as a list of possible workflow steps.

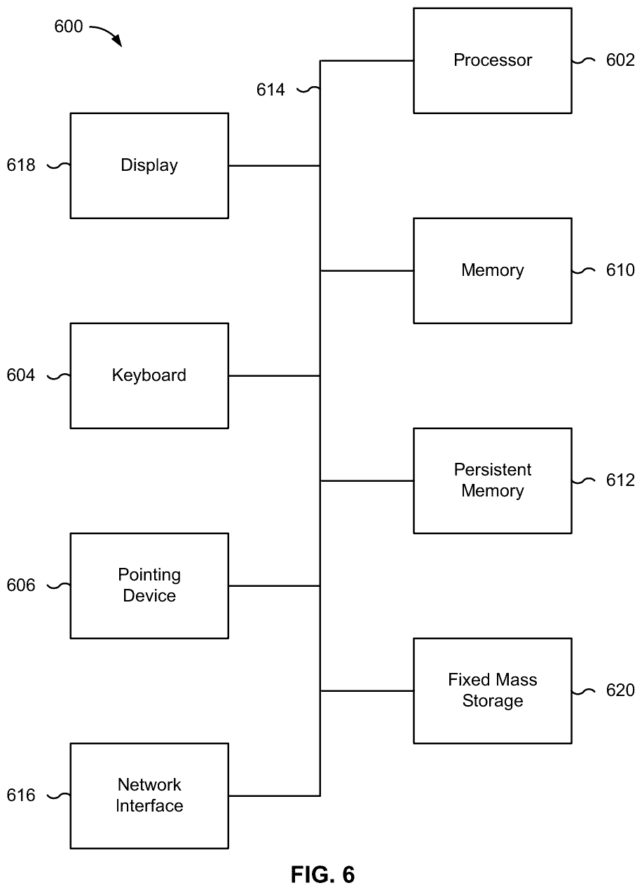

In some embodiments, workflow discovery unit 100 of FIG. 1 and/or workflow discovery unit 200 of FIG. 2A (including their respective components) are comprised of computer program instructions that are executed on a general-purpose processor, e.g., a central processing unit (CPU), of a programmed computer system. FIG. 6 illustrates an example of a programmed computer system. It is also possible for the logic of workflow discovery unit 100 of FIG. 1 and/or workflow discovery unit 200 of FIG. 2A to be executed on other hardware, e.g., executed using an application-specific integrated circuit (ASIC) or a field programmable gate array (FPGA).

FIG. 3 illustrates an example of an invented step. FIG. 3 is described above with respect to the descriptions for FIG. 1 and FIGS. 2A-B.

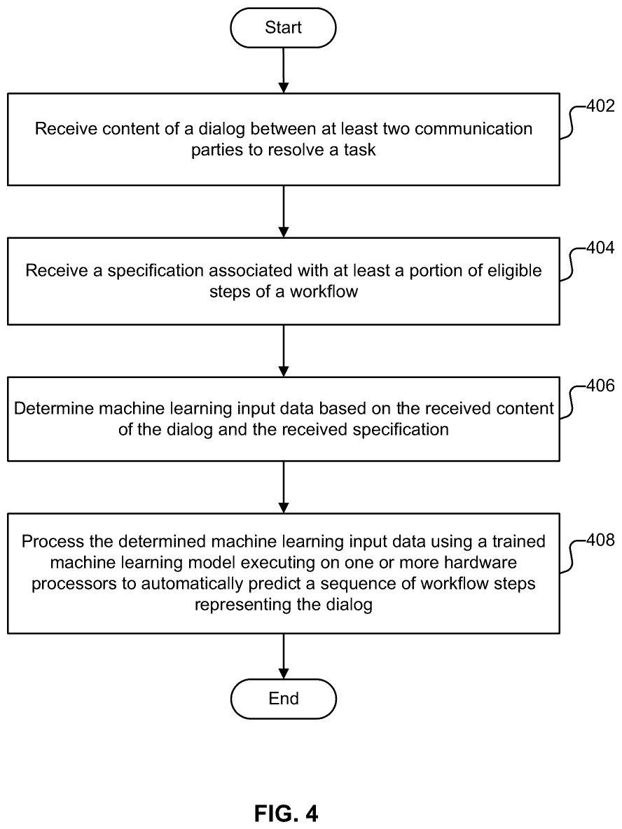

FIG. 4 is a flow diagram illustrating an embodiment of a process for predicting workflow steps. In some embodiments, at least a portion of the process of FIG. 4 is performed by workflow discovery unit 100 of FIG. 1 and/or workflow discovery unit 200 of FIG. 2A.

At 402, content of a dialog between at least two communication parties to resolve a task is received. In some embodiments, the content of the dialog is a collection of utterances in text format. The two communication parties may be comprised of two humans, one human and one virtual agent (e.g., a chatbot), or two virtual agents.

At 404, a specification associated with at least a portion of eligible steps of a workflow is received. The specification of at least the portion of eligible steps can be omitted in some operational modes (e.g., predicting steps seen during training). In some embodiments, the specification is provided in a text format. For example, the specification may be a text list of at least the portion of eligible steps. In various embodiments, the at least the portion of eligible steps is associated with a specific domain. Examples of domains include general customer service, customer service for a specific topic (e.g., travel reservation, dining reservation, etc.), technical support, information technology support, etc. In various embodiments, the eligible steps differ based on the domain.

At 406, machine learning input data is determined based on the received content of the dialog and the received specification. In some embodiments, determining the machine learning input data includes combining the received content of the dialog and the received specification according to a specific format.

At 408, the determined machine learning input data is processed using a trained machine learning model executing on one or more hardware processors to automatically predict a sequence of workflow steps representing the dialog. In some embodiments, the machine learning model is text-to-text model 104 of FIG. 1 and/or text-to-text model 204 of FIG. 2A. In various embodiments, at least a portion of the workflow steps in the predicted sequence of workflow steps are included in the at least the portion of eligible steps. It is also possible for the machine learning model to invent workflow steps that are not included in the at least the portion of eligible steps.

FIG. 5 is a flow diagram illustrating an embodiment of a process for training a machine learning model to predict workflow steps. In some embodiments, the process of FIG. 5 is utilized to train text-to-text model 104 of FIG. 1 and/or text-to-text model 204 of FIG. 2A.

At 502, a machine learning model is pre-trained. In various embodiments, the machine learning model is a text-to-text model. In this stage, the model may be pre-trained using a mixture of unlabeled and labeled text. The unlabeled data can be used for an unsupervised denoising objective, and the labeled data can be used for a supervised text-to-text language modeling objective. Here, the machine learning model may be trained to perform the general task of “understanding” language using a masked language model objective.

At 504, the machine learning model is trained to perform a summarization task. In this stage, in various embodiments, the machine learning model is fine-tuned using a labeled dataset in a supervised mode to perform a text summarization task for which the input is a relatively large amount of text (e.g., a paragraph) and the output is a short summary (e.g., a sentence). For this stage of training, in various embodiments, the amount of training data used is less than the amount of training data used to pre-train the machine learning model.

At 506, the machine learning model is trained to perform a workflow discovery task. In this stage, in various embodiments, the machine learning model is fine-tuned in a supervised mode using a labeled dataset to perform the workflow discovery task in two modes. In the first mode, the input includes only dialogue utterances, and in the second mode, the input includes dialogue utterances and a workflow steps domain. In both modes, the target output is a workflow (e.g., comprising steps and/or step parameters) that summarizes the input. For both modes, a dialogue of utterances and a manually generated summarization of the dialogue of utterances in the format of a sequence of workflow steps (a ground truth workflow) would be included in each training instance. The order of utterances and corresponding workflow steps can be rearranged to generate different training instances. These different training instances can be utilized to train the machine learning model to be invariant to workflow step order. For this stage of training, in various embodiments, the amount of training data used is less than the amount of training data used to train the machine learning model to perform the summarization task. Once the machine learning model is trained, it can be adapted to a new domain for the workflow discovery task using very few labeled samples. In some embodiments, only a few training instances are utilized to train the machine learning model for specific aspects of the workflow discovery task. For example, only a few training instances (e.g., one, two, or three training instances) may be utilized to train the machine learning model for each new domain.

FIG. 6 is a functional diagram illustrating a programmed computer system. In some embodiments, the processes of FIGS. 4 and/or 5 are executed by computer system 600. Computer system 600 is an example of a processor.

In the example shown, computer system 600 includes various subsystems as described below. Computer system 600 includes at least one microprocessor subsystem (also referred to as a processor or a central processing unit (CPU)) 602. Computer system 600 can be physical or virtual (e.g., a virtual machine). For example, processor 602 can be implemented by a single-chip processor or by multiple processors. In some embodiments, processor 602 is a general-purpose digital processor that controls the operation of computer system 600. Using instructions retrieved from memory 610, processor 602 controls the reception and manipulation of input data, and the output and display of data on output devices (e.g., display 618).

Processor 602 is coupled bi-directionally with memory 610, which can include a first primary storage, typically a random-access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 602. Also, as is well known in the art, primary storage typically includes basic operating instructions, program code, data, and objects used by the processor 602 to perform its functions (e.g., programmed instructions). For example, memory 610 can include any suitable computer-readable storage media, described below, depending on whether, for example, data access needs to be bi-directional or uni-directional. For example, processor 602 can also directly and very rapidly retrieve and store frequently needed data in a cache memory (not shown).

Persistent memory 612 (e.g., a removable mass storage device) provides additional data storage capacity for computer system 600, and is coupled either bi-directionally (read/write) or uni-directionally (read only) to processor 602. For example, persistent memory 612 can also include computer-readable media such as magnetic tape, flash memory, PC-CARDS, portable mass storage devices, holographic storage devices, and other storage devices. A fixed mass storage 620 can also, for example, provide additional data storage capacity. The most common example of fixed mass storage 620 is a hard disk drive. Persistent memory 612 and fixed mass storage 620 generally store additional programming instructions, data, and the like that typically are not in active use by the processor 602. It will be appreciated that the information retained within persistent memory 612 and fixed mass storages 620 can be incorporated, if needed, in standard fashion as part of memory 610 (e.g., RAM) as virtual memory.

In addition to providing processor 602 access to storage subsystems, bus 614 can also be used to provide access to other subsystems and devices. As shown, these can include a display monitor 618, a network interface 616, a keyboard 604, and a pointing device 606, as well as an auxiliary input/output device interface, a sound card, speakers, and other subsystems as needed. For example, pointing device 606 can be a mouse, stylus, track ball, or tablet, and is useful for interacting with a graphical user interface.

Network interface 616 allows processor 602 to be coupled to another computer, computer network, or telecommunications network using a network connection as shown. For example, through network interface 616, processor 602 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 602 can be used to connect computer system 600 to an external network and transfer data according to standard protocols. Processes can be executed on processor 602, or can be performed across a network such as the Internet, intranet networks, or local area networks, in conjunction with a remote processor that shares a portion of the processing. Additional mass storage devices (not shown) can also be connected to processor 602 through network interface 616.

An auxiliary I/O device interface (not shown) can be used in conjunction with computer system 600. The auxiliary I/O device interface can include general and customized interfaces that allow processor 602 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: magnetic media such as hard disks, floppy disks, and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code, as produced, for example, by a compiler, or files containing higher level code (e.g., script) that can be executed using an interpreter.

The computer system shown in FIG. 6 is but an example of a computer system suitable for use with the various embodiments disclosed herein. Other computer systems suitable for such use can include additional or fewer subsystems. In addition, bus 614 is illustrative of any interconnection scheme serving to link the subsystems. Other computer architectures having different configurations of subsystems can also be utilized.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
receiving content of a dialog between at least two communication parties to resolve a task;
receiving a specification associated with at least a portion of eligible steps of a workflow;
determining machine learning input data based on the received content of the dialog and the received specification; and
processing the determined machine learning input data using a trained machine learning model executing on one or more hardware processors to automatically predict a sequence of workflow steps representing the dialog.

2. The method of claim 1, wherein the content of the dialog is comprised of a plurality of natural language utterances.

3. The method of claim 2, wherein the plurality of natural language utterances is arranged in a sequential time order associated with when the utterances occurred.

4. The method of claim 1, wherein the at least two communication parties include at least one communication party that is a virtual agent.

5. The method of claim 1, wherein the at least two communication parties include at least two communication parties that are virtual agents.

6. The method of claim 1, wherein the task includes a customer support task.

7. The method of claim 1, wherein the specification has been selected from a specified list of specification options.

8. The method of claim 7, wherein the specified list of specification options has been determined using a second machine learning model that has been trained to automatically predict a workflow steps domain based on an input dialog.

9. The method of claim 1, wherein each step of the at least the portion of eligible steps is semantically related to the task.

10. The method of claim 1, wherein determining the machine learning input data includes combining the received content of the dialog and the received specification according to a specific textual format.

11. The method of claim 1, wherein the trained machine learning model is a text-to-text pre-trained language model.

12. The method of claim 11, wherein the text-to-text pre-trained language model includes an encoder-decoder architecture.

13. The method of claim 1, wherein the trained machine learning model has been pre-trained on a language dataset.

14. The method of claim 13, wherein the language dataset includes a mixture of unlabeled and labeled text.

15. The method of claim 13, wherein the trained machine learning model has been further trained on an additional dataset to perform a summarization task.

16. The method of claim 15, wherein the additional dataset is smaller than the language dataset.

17. The method of claim 15, wherein the trained machine learning model has been further trained to perform a workflow discovery task.

18. The method of claim 1, wherein the sequence of workflow steps comprises a plurality of textual descriptions of actions taken in sequential order to resolve the task.

19. A system, comprising:
one or more processors configured to:
receive content of a dialog between at least two communication parties to resolve a task;
receive a specification associated with at least a portion of eligible steps of a workflow;
determine machine learning input data based on the received content of the dialog and the received specification; and
process the determined machine learning input data using a trained machine learning model to automatically predict a sequence of workflow steps representing the dialog; and
a memory coupled to at least one of the one or more processors and configured to provide at least one of the one or more processors with instructions.

20. A computer program product embodied in a non-transitory computer readable medium and comprising computer instructions for:
receiving content of a dialog between at least two communication parties to resolve a task;
receiving a specification associated with at least a portion of eligible steps of a workflow;
determining machine learning input data based on the received content of the dialog and the received specification; and
processing the determined machine learning input data using a trained machine learning model executing on one or more hardware processors to automatically predict a sequence of workflow steps representing the dialog.
